(19) United States
(12) Patent Application Publication
(10) Pub. No.: US 2025/0289199 A1
(43) Pub. Date: Sep. 18, 2025

(54) PREDICTIVE MAINTENANCE SYSTEM FOR DIE OF PRESS MACHINE, AND METHOD FOR PREDICTIVE MAINTENANCE

(71) Applicant: KOMATSU INDUSTRIES CORPORATION, Kanazawa-shi (JP)

(72) Inventors: Hiroshi KINOSHITA, Ishikawa (JP); Yusuke MASATO, Ishikawa (JP); Nobuo MORI, Ishikawa (JP); Shinichirou NAKAMURA, Ishikawa (JP); Eiji DOBA, Ishikawa (JP)

(21) Appl. No.: 19/014,955

(22) Filed: Jan. 9, 2025

(30) Foreign Application Priority Data
Mar. 14, 2024 (JP) 2024-040296

(51) Int. Cl. B30B 15/14; B30B 15/00

(52) U.S. Cl. CPC B30B 15/148; B30B 15/0094

(57) ABSTRACT

A predictive maintenance system for a die of a press machine includes a load sensor, a data collection device, and a diagnosis device. The load sensor detects a press load applied to the die. The data collection device collects load data indicating time series data of the press load. The diagnosis device diagnoses degradation of the die based on a waveform of the load data.

### CROSS-REFERENCE TO RELATED APPLICATIONS

This application claims priority to Japanese Patent Application No. 2024-040296 filed on Mar. 14, 2024, the disclosure of which is hereby incorporated herein by reference in its entirety.

### BACKGROUND

### Field of the Invention

The present disclosure relates to a predictive maintenance system for a die of a press machine, and a method for predictive maintenance

### Background Information

A press machine performs pressing by pressing a die onto a workpiece. For example, in the press machine of Japanese Laid-Open Patent Publication No. 2018-167328, an upper die is attached to the lower surface of a slide. A bolster is disposed below the slide and a lower die is attached to the upper surface of the bolster. The slide moves up and down by means of a drive mechanism such as a motor. The press machine performs pressing by lowering the slide and pressing the upper die onto the workpiece set on the lower die.

### SUMMARY

The die degrades due to wear from continuous use. As a result, maintenance of the die is necessary in order to sustain a high quality of pressing. For example, it is thought that an exchange period for the die is determined by measuring the dimensions of the die. In this case, a long time is required because it is necessary to remove the die from the press machine and measure the die with a dedicated measurement apparatus. In addition, there is a possibility that the accuracy of the pressing may be affected by removing the die. Alternatively, it is thought that the exchange period of the die is determined based on the number of shots of the pressing. In this case, it is difficult to accurately determine degradation of the die. An object of the present disclosure is to be able to accurately and easily determine degradation of a die.

A system according to an aspect of the present disclosure is a predictive maintenance system for a die of a press machine. The system includes a load sensor, a data collection device, and a diagnosis device. The load sensor detects a press load applied to the die. The data collection device collects load data indicating time series data of the press loads. The diagnosis device diagnoses degradation of the die based on a waveform of the load data.

A method according to another aspect of the present disclosure is a method executed by a computer for predictive maintenance for a die of a press machine. The method includes acquiring load data that indicates time series data of press loads on the die, and diagnosing degradation of the die based on a waveform of the load data.

### BRIEF DESCRIPTION OF THE DRAWINGS

FIG. 1 is a schematic view illustrating a predictive maintenance system according to an embodiment.

FIG. 2 is a front view of a press machine.

FIG. 3 is a flow chart illustrating processing for diagnosing a die.

FIG. 4 illustrates an example of load data.

FIG. 5 illustrates an example of offset value data.

FIG. 6 illustrates an example of load data in an analysis range.

FIG. 7 illustrates an example of a tendency value graph.

### DETAILED DESCRIPTION OF EMBODIMENT(S)

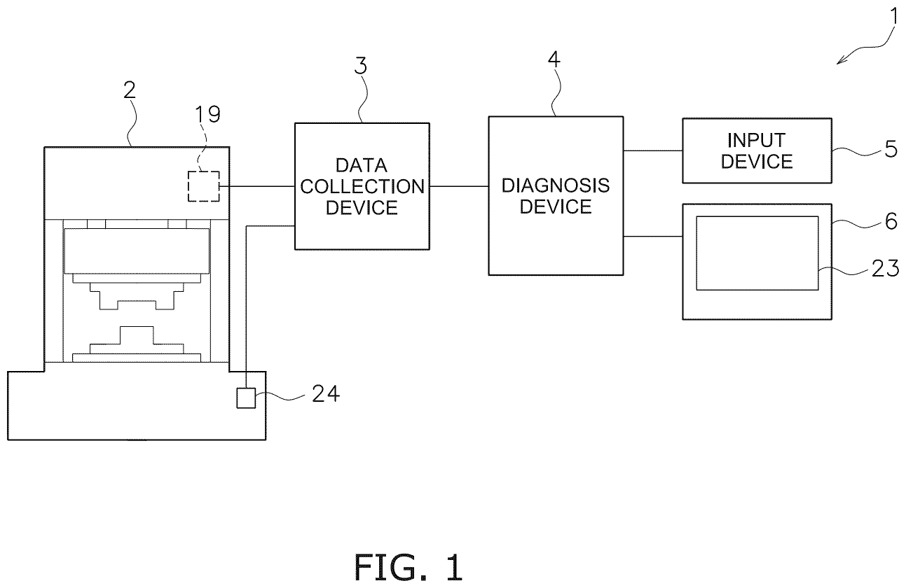

A predictive maintenance system for a die of a press machine according to an embodiment will be discussed below with reference to the drawings. FIG. 1 is a schematic view illustrating a predictive maintenance system 1 according to the embodiment. As illustrated in FIG. 1, the predictive maintenance system 1 includes a press machine 2, a data collection device 3, a diagnosis device 4, an input device 5, and an output device 6.

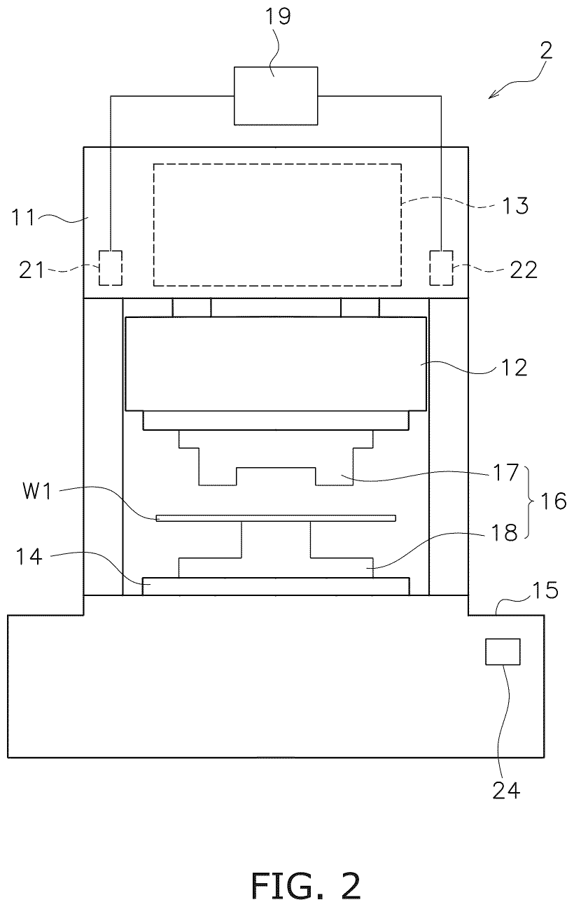

FIG. 2 is a front view of the press machine 2. The press machine 2 includes a supporting frame 11, a slide 12, a slide drive device 13, a bolster 14, and a base 15. The supporting frame 11 is disposed on the base 15. The slide 12 is supported to be movable up and down with respect to the supporting frame 11. The slide drive device 13 causes the slide 12 to operate. The slide drive device 13 includes, for example, a motor and a transmission mechanism. The transmission mechanism converts the rotation of the motor to linear motion and transmits the linear motion to the slide 12. The bolster 14 is disposed below the slider 12. The base 15 is disposed below the bolster 14 and supports the bolster 14.

A die 16 is attached to the press machine 2. The die 16 includes an upper die 17 and a lower die 18. The upper die 17 is attached to the slide 12. The lower die 18 is attached to the bolster 14. The press machine 2 performs pressing by lowering the slide 12 and pressing the upper die 17 onto a workpiece W1 set on the lower die 18.

The press machine 2 includes a load sensor 19. The load sensor 19 detects a press load applied to the die 16. The load sensor 19 includes, for example, strain gauges 21 and 22. The strain gauges 21 and 22 are attached to the supporting frame 11. The load sensor 19 detects the press load applied to the die 16 through distortion of the supporting frame 11. The load sensor 19 outputs a load signal that indicates the press load.

As illustrated in FIG. 1, the data collection device 3 is communicably connected to the load sensor 19. The data collection device 3 is realized by a computer that includes a processor and a storage device. The data collection device 3 receives the load signal from the load sensor 19. The data collection device 3 samples and collects the press loads over a predetermined sampling period from the load signals. The data collection device 3 generates and stores load data that indicates time series data of the press loads from the sampled press loads.

The diagnosis device 4 is communicably connected to the data collection device 3. The diagnosis device 4 is realized by a computer that includes a processor and a storage device. The diagnosis device 4 may be a cloud server, for example. In this case, the diagnosis device 4 communicates with the data collection device 3 over a communication network such as the Internet. Alternatively, the diagnosis device 4 may be a computer that is disposed in the same factory as the press machine 2 and the data collection device 3. The diagnosis device 4 receives the load data from the data collection device 3. The diagnosis device 4 diagnoses degradation of the die 16 based on a waveform of the load data. The diagnosis of the die 16 by the diagnosis device 4 is explained below.

The input device 5 is operable by a user in order to set information for diagnosing the die 16. The input device 5 is communicably connected to the diagnosis device 4. The input device 5 transmits the information input by the user to the diagnosis device 4. The output device 6 is communicably connected to the diagnosis device 4. The output device 6 includes a display 23. The output device 6 may be connected to the diagnosis device 4 through the input device 5. The output device 6 displays a screen pertaining to the diagnosis of the die 16 based on display signals from the diagnosis device 4.

The input device 5 and the output device 6 are realized by computers that include a processor and a storage device. The output device 6 may be a touch screen integrated with the input device 5. The input device 5 and the output device 6 may be computers that are disposed in the same factory as the press machine 2 and the data collection device 3. Alternatively, the input device 5 and the output device 6 may be able to communicate with the diagnosis device 4 over a communication network such as the Internet.

The predictive maintenance system 1 includes a reset switch 24. The reset switch 24 is communicably connected to the data collection device 3. The reset switch 24 is operable by a user in order to reset the diagnosis of the die 16. When the reset switch 24 is operated, a reset signal for resetting the diagnosis of the die 16 is transmitted to the data collection device 3. The reset signal may be transmitted from the input device 5 by means of an operation on the input device 5. The data collection device 3 transmits a reset instruction for resetting the diagnosis of the die 16 to the diagnosis device 4 upon receiving the reset signal.

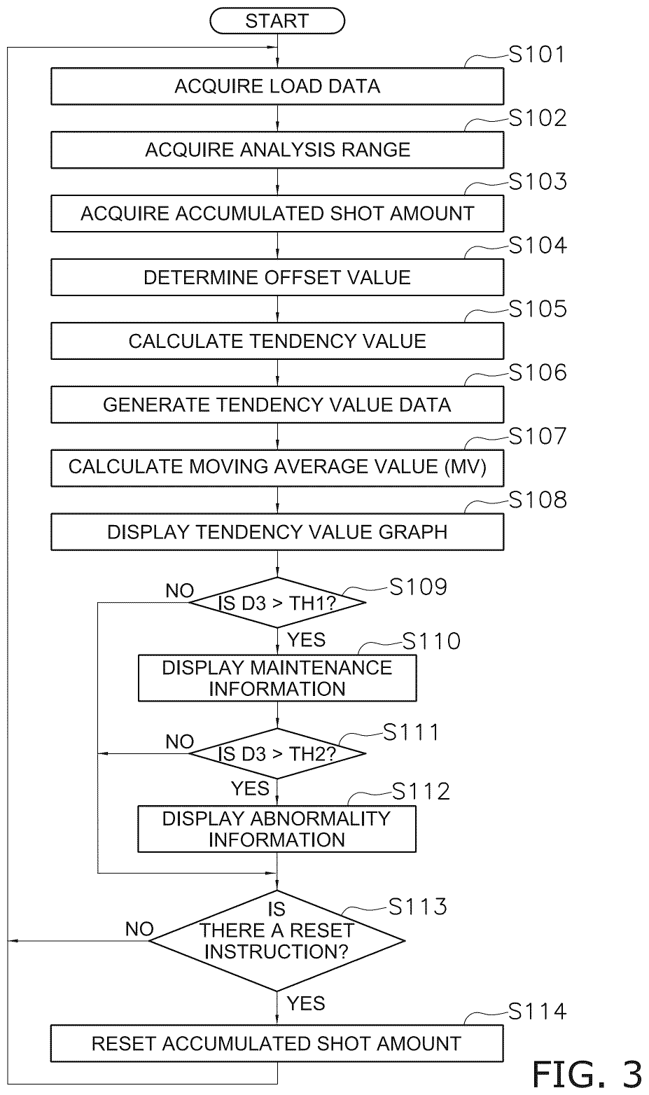

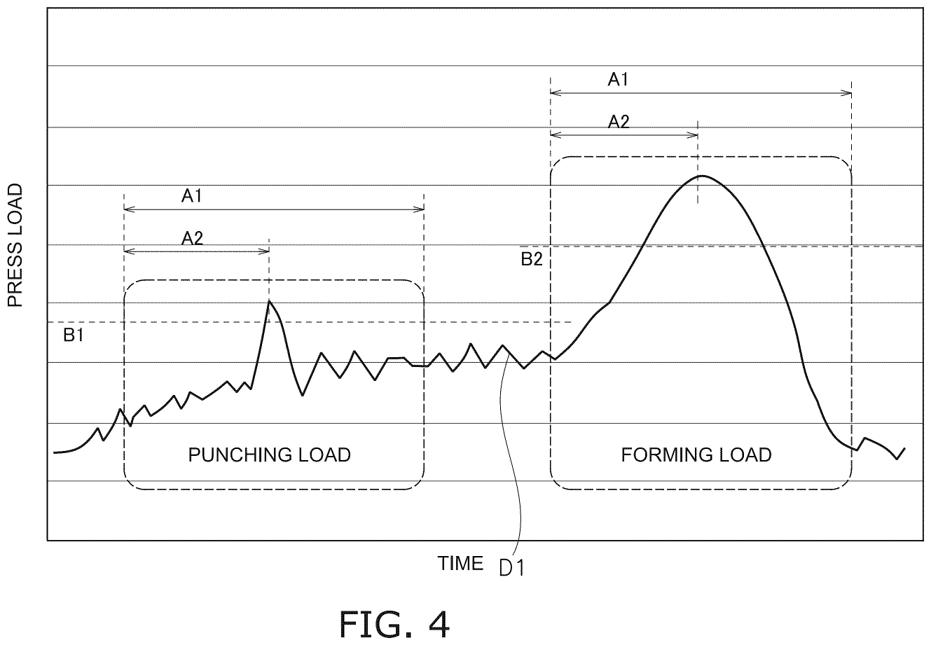

Processing for diagnosing the die 16 will be explained next. FIG. 3 is a flow chart illustrating processing executed by the diagnosis device 4 for diagnosing the die 16. As illustrated in step S101 in FIG. 3, the diagnosis device 4 acquires the load data. The diagnosis device 4 acquires the load data from the data collection device 3. FIG. 4 illustrates an example of load data D1. As illustrated in FIG. 4, the load data D1 represents a waveform of a time sequence of the press load.

In step S102, the diagnosis device 4 acquires an analysis range. The user inputs the analysis range by operating the input device 5. The diagnosis device 4 sets the analysis range based on the input by the user received by the input device 5. The analysis range indicates the range of the load data D1 to be used for diagnosing degradation of the die 16. As illustrated in FIG. 4, the analysis range includes a data amount A1 of the load data D1 from the beginning to the end of the analysis range, and a data amount A2 of the load data D1 from the beginning to the peak of the analysis range.

Additionally, the analysis range includes a first load threshold B1 and a second load threshold B2 for determining the peak of the load data D1. The first load threshold B1 is a threshold of the press load for determining the peak in a punching load. The punching load is the press load when punching the workpiece W1 out of the raw material. The second load threshold B2 is a threshold of the press load for determining the peak in a forming load. The forming load is the press load when forming the workpiece W1.

In step S103, the diagnosis device 4 acquires an accumulated shot amount. The shot amount is the number of times pressing is performed by the die 16, and the accumulated shot amount is the number of shots from the previous reset instruction. The press machine 2 counts the shot amount and the data collection device 3 acquires the shot amount from the press machine 2 and transmits the shot amount to the diagnosis device 4. Alternatively, the diagnosis device 4 may count the number of times of the forming load in the waveform of the press load, as the shot amount.

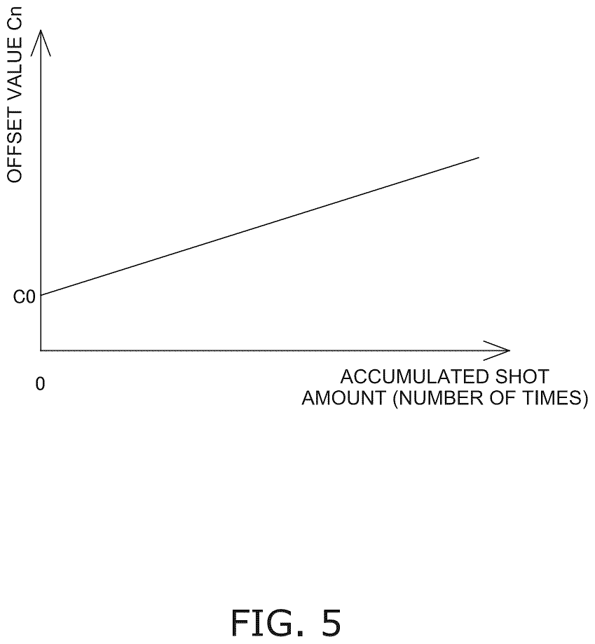

In step S104, the diagnosis device 4 determines an offset value. The diagnosis device 4 stores the offset value data illustrated in FIG. 5. The offset value data defines the relationship between the accumulated shot amount and the offset value. The offset value increases in accordance with an increase in the accumulated shot amount in the offset value data. The diagnosis device 4 refers to the offset value data and determines the offset value from the accumulated shot amount.

In step S105, the diagnosis device 4 calculates a tendency value. The tendency value indicates the tendency of change of the load data D1. The diagnosis device 4 calculates the tendency value based on the load data D1 within the analysis range. The diagnosis device 4 calculates the tendency value using the following formula (1).

$$Tv = L max - L min + Cn \qquad ( 1 )$$

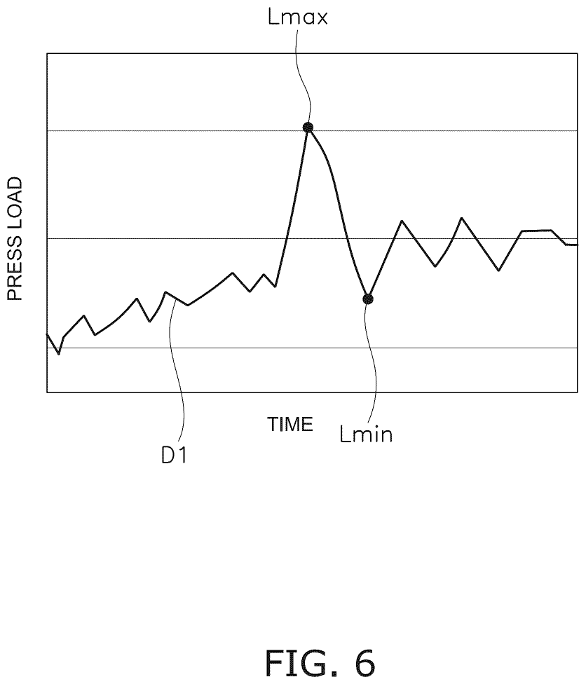

Tv is the tendency value. As illustrated in FIG. 6, Lmax is the maximum value of the load data D1 within the analysis range. Lmin is the minimum value after the maximum value Lmax within the analysis range. Cn is the offset value. That is, the diagnosis device 4 calculates the tendency value based on the difference between the maximum value and the minimum value of the load data D1 within the analysis range, and the offset value.

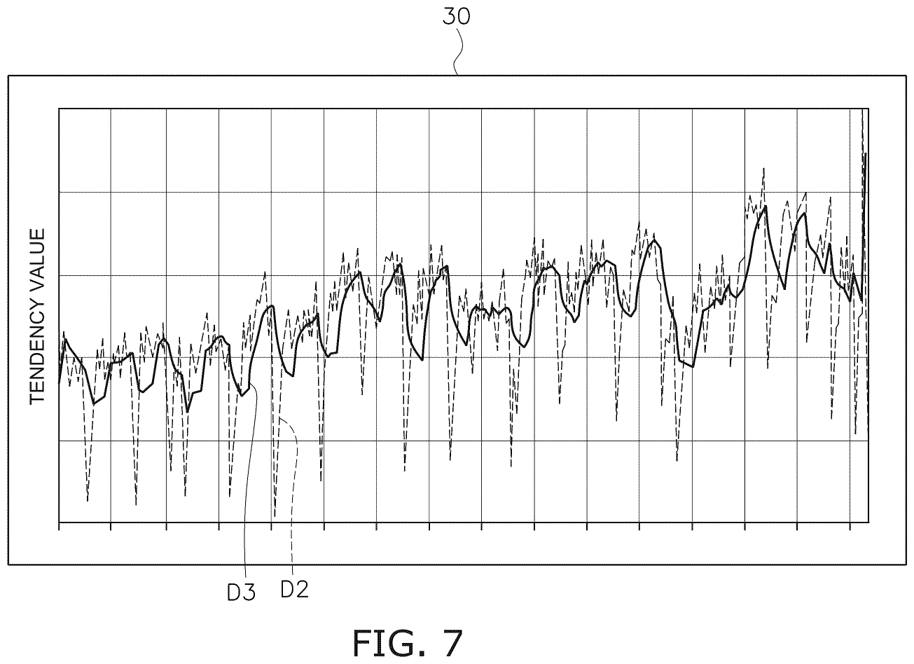

In step S106, the diagnosis device 4 generates tendency value data. The tendency value data is time series data of the tendency values. As illustrated in FIG. 7, the tendency value data D2 represents a waveform of the time sequence of the tendency values. In step S107, the diagnosis device 4 calculates a moving average value D3 of the tendency value data D2. In step S108, the diagnosis device 4 displays a tendency value graph 30 on the display 23. FIG. 7 illustrates an example of the tendency value graph 30. As illustrated in FIG. 7, the tendency value graph 30 includes a waveform of the tendency value data D2 and a waveform of the moving average value D3 of the tendency value data D2.

In step S109, the diagnosis device 4 determines whether the moving average value D3 of the tendency value data D2 is greater than a first diagnosis threshold TH1. The first diagnosis threshold TH1 is a threshold for diagnosing the need for maintenance of the die 16. The diagnosis device 4 sets the first diagnosis threshold TH1 based on an input by the user received by the input device 5. When the moving average value D3 of the tendency value data D2 is greater than the first diagnosis threshold TH1, the processing advances to step S110.

In step S110, maintenance information is displayed on the display 23. The maintenance information is information requesting maintenance such as replacement of the die 16. The maintenance information is represented by text or an image. The maintenance information may be displayed on an application screen for diagnosing an abnormality of the die 16. Alternatively, the maintenance information may be transmitted by email and displayed.

In step S111, the diagnosis device 4 determines whether the moving average value D3 of the tendency value data D2 is greater than a second diagnosis threshold TH2. The second diagnosis threshold TH2 is a threshold for determining an abnormality of the die 16. The diagnosis device 4 determines the second diagnosis threshold TH2 from past load data D1. For example, the diagnosis device 4 determines the maximum value of tendency values in the past as the second diagnosis threshold TH2. When the moving average value D3 of the tendency value data D2 is greater than the second diagnosis threshold TH2, the processing advances to step S112.

In step S112, the diagnosis device 4 displays abnormality information on the display 23. The abnormality information is information for reporting an abnormality of the die 16. The abnormality information is displayed by text or an image. The abnormality information may be displayed on an application screen for diagnosing abnormalities of the die 16. Alternatively, the abnormality information may be transmitted by email and displayed.

In step S113, the diagnosis device 4 determines whether there is a reset instruction. The diagnosis device 4 receives the reset instruction when the abovementioned reset switch 24 is operated. For example, the user operates the reset switch 24 when the die 16 is replaced to reset the diagnosis of the die 16. Alternatively, the user resets the diagnosis of the die 16 when the material of the workpiece W1 is changed.

When the diagnosis device 4 has determined that there is a reset instruction, the diagnosis device 4 resets the accumulated shot amount in step S114. Consequently, the offset value is reset to an initial value CO as illustrated in FIG. 5. The diagnosis device 4 then repeats the abovementioned processing. When there is no reset instruction in step S113, the diagnosis device 4 repeats the above processing without resetting the accumulated shot amount.

In the predictive maintenance system 1 of the die 16 of the press machine 2 according to the present embodiment discussed above, the time series data of the press loads applied to the die 16 is collected as the load data D1. Degradation of the die 16 is then diagnosed based on a waveform of the load data D1. As a result, degradation of the die 16 can be diagnosed accurately and easily.

Although an embodiment of the present invention has been described so far, the present invention is not limited to the above embodiment and various modifications may be made within the scope of the invention.

The configuration of the press machine 2 is not limited to the above embodiment and may be changed. For example, the load sensor 19 may be attached to the die 16. The load sensor 19 is not limited to a strain gauge and alternatively may be another type of sensor such as an acoustic emission (AE) sensor.

The processing for diagnosing the die 16 is not limited to the above embodiment and may be modified. For example, the offset value may be multiplied by the difference between the maximum value and the minimum value of the tendency values. The offset value is not limited to a value corresponding to the accumulated shot amount and may be a value corresponding to the temperature of the die 16 or the thickness of the material of the workpiece W1.

The diagnosis device 4 may be compared the first and second thresholds TH1 and TH2 to the tendency values, not limited to the moving average data D3 of the tendency values. The tendency values are not limited to the above embodiment and may be changed. For example, the tendency values may be Mahalanobis distances calculated with the Maharanobis-Taguchi (MT) system by using the load data D1 of the analysis range as a multidimensional vector. Alternatively, the tendency values may be Mahalanobis distances calculated with the MT system based on the average and the standard deviation of the load data D1 within the analysis range. Alternatively, the tendency values may be Mahalanobis distances calculated with the MT system based on a result obtained by performing FFT analysis on the load data D1 within the analysis range.

Alternatively, the tendency values may be values calculated by analyzing the load data D1 within the analysis range by a multivariate analysis other than the MT system. Alternatively, the tendency values may be integrated values of absolute values of the data for each sampling of the load data D1 within the analysis range. Alternatively, the tendency value may merely be the maximum value of the load data D1 within the analysis range. Alternatively, the tendency value may be the difference between the press load at the start of the punching step for punching the workpiece W1 from the raw material, and the maximum value of the press load.

What is claimed is:

1. A predictive maintenance system for a die of a press machine, the predictive maintenance system comprising:
a load sensor that detects a press load applied to the die;
a data collection device configured to collect load data indicating time series data of the press load; and
a diagnosis device configured to diagnose degradation of the die based on a waveform of the load data.

2. The predictive maintenance system according to claim 1, further comprising:
an input device configured to receive an input of an analysis range of the load data,
the diagnosis device being configured to diagnose the degradation of the die based on the load data within the analysis range.

3. The predictive maintenance system according to claim 2, wherein
the analysis range includes a data amount of the load data from a beginning to an end of the analysis range.

4. The predictive maintenance system according to claim 2, wherein
the analysis range includes a data amount of the load data from a beginning to a peak of the analysis range.

5. The predictive maintenance system according to claim 2, wherein
the analysis range includes a load threshold usable to determine a peak of the load data.

6. The predictive maintenance system according to claim 2, wherein
the diagnosis device is configured to
calculate a tendency value indicating a tendency of change of the load data based on the load data within the analysis range, and
diagnose the degradation of the die based on the tendency value

7. The predictive maintenance system according to claim 6, wherein
the diagnosis device is configured to calculate the tendency value based on a difference between a maximum value and a minimum value of the load data within the analysis range.

8. The predictive maintenance system according to claim 7, wherein
the diagnosis device is configured to
acquire an offset value that increases in accordance with an increase in a shot amount of the press machine, and
calculate the tendency value based on the difference between the maximum value and the minimum value of the load data within the analysis range, and the offset value.

9. The predictive maintenance system according to claim 6, further comprising:
a display,
the diagnosis device being configured to display a waveform of tendency value data indicating time series data of the tendency values on the display.

10. The predictive maintenance system according to claim 6, further comprising:
an output device,
the diagnosis device being configured to
acquire a first diagnoses threshold set via the input device,
diagnose whether maintenance of the die is necessary or not by comparing the first diagnosis threshold and the tendency value, and
cause the output device to output information indicating that the maintenance of the die is necessary when the diagnosis device has diagnosed that maintenance of the die is necessary.

11. The predictive maintenance system according to claim 6, further comprising:
an output device,
the diagnosis device being configured to
diagnose an abnormality of the die by comparing a second diagnosis threshold for determining an abnormality of the die, and the tendency value, and
cause the output device to output information for reporting the abnormality of the die when the diagnosis device has diagnosed that the die is abnormal.

12. A method executed by a computer for predictive maintenance for a die of a press machine, the method comprising:
acquiring load data indicating time series data of a press load on the die; and
diagnosing degradation of the die based on a waveform of the load data.

13. The method according to claim 12, further comprising:
acquiring an analysis range of the load data; and
diagnosing the degradation of the die based on the load data within the analysis range.

14. The method according to claim 13, further comprising:
calculating a tendency value indicating a tendency of change of the load data based on the load data within the analysis range; and
diagnosing the degradation of the die based on the tendency value.

15. The method according to claim 14, further comprising:
calculating the tendency value based on a difference between a maximum value and a minimum value of the load data within the analysis range.
